(19) United States
(12) Patent Application Publication
(10) Pub. No.: US 2011/0115479 A1
(43) Pub. Date: May 19, 2011

(54) Through Shaft Rotary Position Sensor

(76) Inventor: Patrick B. Blakesley, Bristol, IN (US)

(21) Appl. No.: 12/945,028

(22) Filed: Nov. 12, 2010

Related U.S. Application Data
(60) Provisional application No. 61/281,132, filed on Nov. 13, 2009.

(51) Int. Cl. G01B 7/30

(52) U.S. Cl. 324/207.25

(57) ABSTRACT

A rotary position sensor assembly includes a ring magnet extending around the outer surface of a rotatable through shaft. A sensor which measures changes in the direction of the magnetic flux generated by the magnet in response to rotation of the shaft and a pair of magnet pole pieces are located opposite and spaced from the magnet. The sensor is located between the pair of pole pieces and the pole pieces conduct the magnetic flux over the sensor and nominalize the strength of the magnetic flux sensed by the sensor over the full range of rotation of the shaft relative to the sensor.

### CROSS-REFERENCE TO RELATED APPLICATION

This application claims the benefit of the filing date and disclosure of U.S. Provisional Application Ser. No. 61/281,132 filed on Nov. 13, 2009 which is explicitly incorporated herein by reference as are all references cited therein.

### FIELD OF THE INVENTION

This invention relates to a rotary position sensor assembly and, more specifically, to a non-contacting rotary position sensor assembly using a Hall effect sensor.

### BACKGROUND OF THE INVENTION

Non-contacting rotary position sensor assemblies which are available today for detecting and measuring the rotary position of an object include a magnet and a Hall effect sensor adapted to sense the direction of the magnetic field generated by the magnet in two dimensions. The use of this type of Hall effect sensor is becoming increasingly common for detecting the angle or position of the shaft of the rotary position sensor where the magnet can be mounted to one of the distal end surfaces of the shaft which then allows the Hall effect sensor to be mounted in a relationship and position axial to the center line of the shaft.

This arrangement, however, is not possible in applications where a part requires the use of a through shaft and the end of the through shaft is not available for mounting a magnet thereto. The means and methods available today for sensing the angle and position of such a through shaft sensor have proven to include a variety of limitations and, in certain applications, have required the use of custom Hall effect sensors with custom magnetic field measurement capabilities.

### SUMMARY OF THE INVENTION

The present invention is directed to a rotary position sensor assembly which comprises a shaft, a magnet on the shaft and adapted to generate a magnetic flux having a strength and a direction, a sensor located opposite and spaced from the magnet and adapted to sense and measure a change in the direction of the magnetic flux generated by the magnet in response to a change in the rotary position of the shaft, and a pair of magnet pole pieces which are located opposite and spaced from the magnet and on opposed sides of and spaced from the sensor and are adapted to conduct the magnetic flux over the sensor.

In one embodiment, each of the magnet pole pieces includes a tapered end located opposite and spaced from the sensor to concentrate the magnetic flux over the sensor.

Further, in one embodiment, the magnet is ring shaped and surrounds the shaft, each of the magnet pole pieces is curvilinear and follows the contour of the shaft, and the magnet, the sensor, and the magnet pole pieces are all positioned in a generally co-planar relationship.

Further, according to the invention, the pair of magnet pole pieces nominalize the strength of the magnetic flux generated by the magnet over the full range of rotation of the shaft relative to the sensor.

There are other advantages and features of this invention which will be more readily apparent from the following detailed description of the embodiment of the invention, the drawings, and the appended claims.

### BRIEF DESCRIPTION OF THE DRAWINGS

In the accompanying drawings that form part of the specification, and in which like numerals are employed to designate like parts throughout the same:

FIG. 1 is a simplified, enlarged, broken perspective view of a through shaft rotary position sensor assembly in accordance with the present invention;

FIG. 2 is a simplified, enlarged, top plan view of the through shaft rotary position sensor assembly of FIG. 1 with the through shaft at its zero (0) degree rotary position and depicting the magnetic field or flux generated by the ring magnet and conducted over the sensor; and

FIG. 3 is a simplified, enlarged, top plan view of the through shaft rotary position sensor assembly of FIG. 1 with the through shaft at its ninety (90) degree rotary position and depicting the magnetic field or flux generated by the ring magnet and conducted over the sensor by the magnet pole pieces.

### DETAILED DESCRIPTION OF THE EMBODIMENT

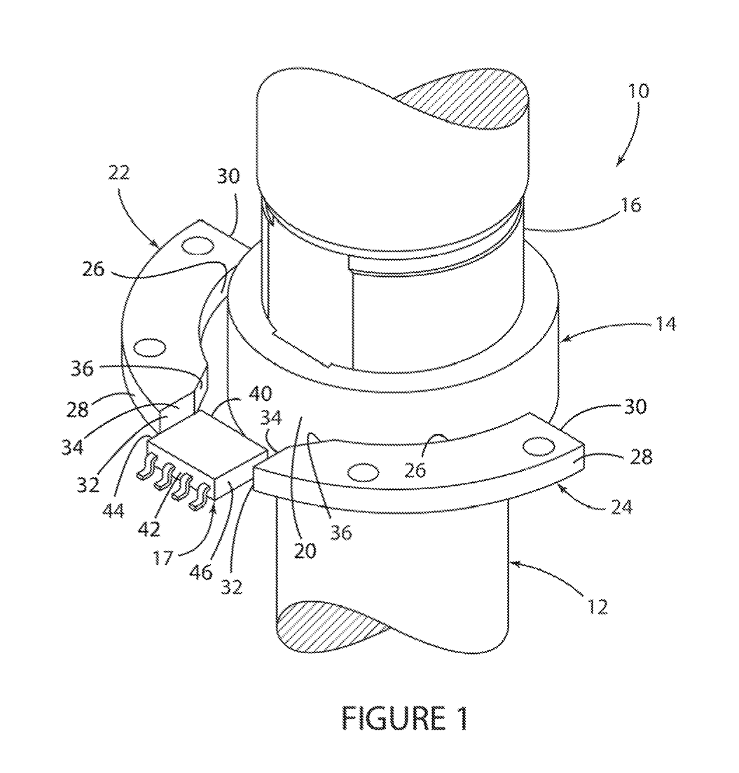

FIGS. 1-3 depict a simplified embodiment of a through shaft non-contacting rotary position sensor assembly 10 in accordance with the present invention which comprises at least the following key elements: an elongate, generally cylindrically-shaped through shaft 12 adapted for coupling to a part (not shown) whose rotary or angular position is required to be measured; a ring magnet 14 surrounding and coupled to the exterior circumferential surface 16 of the through shaft 12; a Hall effect sensor integrated circuit chip 17 located opposite and spaced from the exterior circumferential surface 20 of the ring magnet 14 and positioned in a relationship generally co-planar with the horizontal cross-sectional axis of the ring magnet 14; and a pair of generally curvilinearly-shaped magnet pole pieces 22 and 24 located opposite and spaced from the exterior surface 20 of the ring magnet 14 and positioned in a relationship generally co-planar with both the horizontal cross-sectional axis of the ring magnet 14 and the Hall effect sensor 17.

In the embodiment shown, the magnet pole pieces 22 and 24 are located on opposite sides of, and spaced from, the Hall effect sensor 17 and are curved in a manner which allows the respective magnet pole pieces 22 and 24 to follow the contour of the ring magnet 14 and the shaft 12.

Specifically, in the embodiment shown, each of the magnet pole pieces 22 and 24 is a generally flat, curvilinearly shaped metal plate having a generally constant thickness and width along the full length thereof. Further, in the embodiment shown, the magnet pole pieces 22 and 24 are diametrically opposed mirror images of each other and thus both have the same length, thickness and width. Still further, in the embodiment shown, each of the curvilinear magnet pole pieces 22 and 24 extend around the circumference of the magnet 14 and the shaft 12 from a point spaced from the respective end faces 44 and 46 of the sensor 17 to a point which is spaced a distance of ninety degrees from the sensor 17. Although not shown or described herein, it is understood that the magnet pole pieces 22 and 24 may be mounted to the surface of a sensor assembly support structure such as, for example, the surface of a printed circuit board (not shown).

Each of the magnet pole pieces 22 and 24 includes an interior or inner generally curvilinear and longitudinally extending face 26 which is spaced from, located opposite to, and follows the contour of, the exterior surface 20 of the magnet 14; an exterior or outer generally curvilinear and longitudinally extending face 28 which is spaced from, located opposite to, and is oriented in a relationship generally parallel to, the face 26; and opposed transverse end faces 30 and 32 extending between and joining the ends of the longitudinal faces 26 and 28.

Still more specifically, the end face 30 of each of the magnet pole pieces 22 and 24 is generally straight and is oriented in a relationship generally normal to the faces 26 and 28 of the magnet pole pieces 22 and 24 and the exterior face of the magnet 14. The end face 32 of each of the magnet pole pieces 22 and 24 is located opposite and spaced from the respective opposed side faces 44 and 46 of the integrated circuit chip sensor 17. The end face 32, however, differs from the end face 30 in that the end face 32 includes a first straight segment 34 which is spaced from and disposed in a relationship generally parallel to the respective opposed side faces 44 and 46 of the sensor 17 and a second tapered or angled segment 36 which tapers at approximately a forty five degree angle away from the respective end faces 44 and 46 of the sensor 17 and the first straight segment 34 and terminates in the inner face 26 of each of the respective magnet pole pieces 22 and 24.

The sensor 17 is of the integrated circuit Hall effect variety available from, for example, Melexis Corporation; is adapted for mounting to the surface of a sensor assembly support structure such as, for example, a printed circuit board (not shown); and is adapted to sense and measure changes in the direction of the magnetic field or flux generated by the magnet 14 in response to changes in the rotary position of the shaft 12 and the magnet 14 rather than a change in the strength or intensity of the magnetic field or flux generated by the magnet 14.

The sensor 17 is in the form of an integrated circuit chip which includes a side face 40 located opposite and spaced from the exterior surface 20 of the magnet 14; a side face 42 opposite and spaced from the side face 40; and opposed end faces 44 and 46 extending between the side faces 40 and 42. The end face 44 of the sensor 17 is located opposite and spaced from the end face 32 of the magnet pole piece 22 and the end face 46 of the sensor 17 is located opposite and spaced from the end face 32 of the magnet pole piece 24.

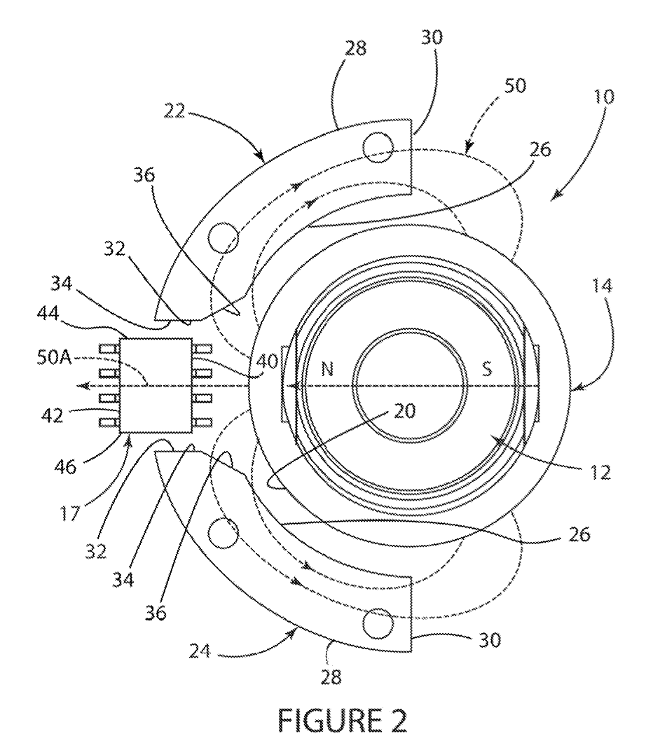

FIG. 2 depicts the generation, travel, orientation, and direction of selected ones of the lines 50 of the magnetic flux or field generated by the magnet 14 when the North (N)-South (S) poles of the ring magnet 14 are oriented generally co-linearly with the sensor 17 including, for example, the generation, travel, orientation, and direction of at least a first magnetic flux or field line 50A from the North pole (N) of the magnet 14 in the direction of and over the sensor 17 in an orientation and direction generally normal to the opposed side faces 40 and 42 of the sensor 17 and in an orientation and direction generally parallel to the opposed end faces 44 and 46 of the sensor 17 and the end face 32 of the respective magnet pole pieces 22 and 24.

In the position of FIG. 2 which corresponds to the zero (0) degree position of the shaft 12, the direction of the magnetic field or flux lines 50 is not affected by the magnet pole pieces 22 and 24 and is radial to the shaft 12. The strength of the magnetic flux or field 50 in this position is decreased only a very small amount by the presence of the pole pieces 22 and 24 conducting some of the magnetic field or flux lines 50 away from the sensor 17.

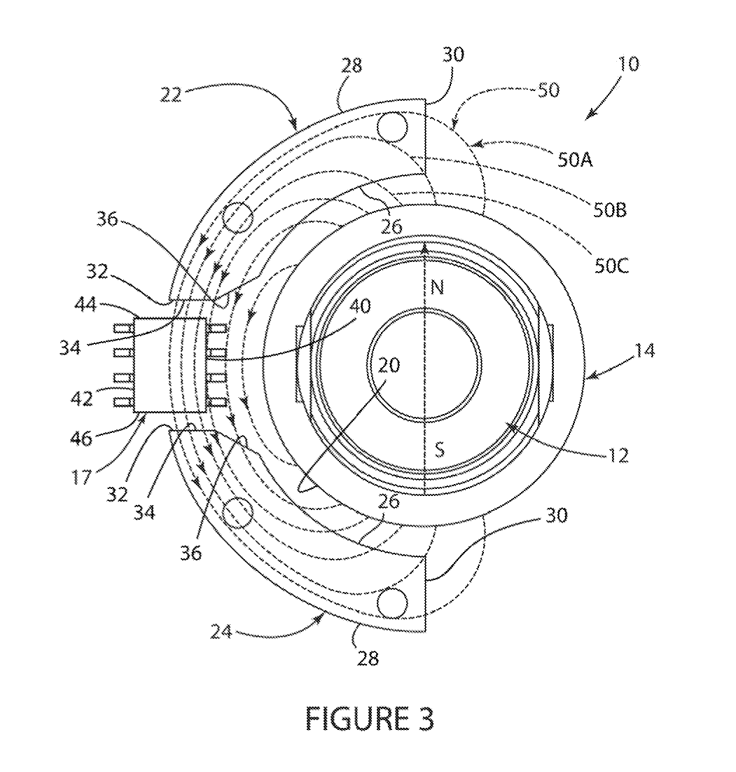

FIG. 3 depicts the generation, travel, orientation, and direction of the magnetic field flux lines 50 when the shaft 12, and thus the ring magnet 14 supported thereon, have been rotated clockwise ninety (90) degrees from the zero (0) degree position of FIG. 2 into the FIG. 3 position in which the North (N) pole of the magnet 14 is located generally opposite and co-linear with the end face 30 of the magnet pole piece 22 and the South (S) pole of the magnet 14 is located generally opposite and co-linear with the end face 30 of the magnet pole piece 24. In this orientation, several of the magnetic field or flux lines 50 including, for example, the field or flux lines 50A, 50B, and 50C travel from the North (N) pole of the magnet 14, curvilinearly over the length of the magnet pole piece 22, over the sensor 17 in an orientation and relationship generally normal to the end faces 44 and 46 of the sensor 17, curvilinearly over the length of the magnet pole piece 24, and then into the South (S) pole of the magnet 14.

As shown in FIG. 3, the direction of the magnetic field or flux lines 50 is not affected by the magnet pole pieces 22 and 24 and is tangential to the shaft 12. The strength of the magnetic field or flux lines 50 over the sensor 17, however, as shown in FIG. 3 is greatly increased by the presence of the respective magnet pole pieces 22 and 24 adjacent the ring magnet 14 and the sensor 17. Normally, in this position and in the absence of the magnet pole pieces 22 and 24, the strength of the magnetic field or flux lines at the sensor 17 would be very small. However, the magnet pole pieces 22 and 24 as positioned in FIG. 3 conduct the strong field from the North (N)-South (S) poles of the magnet 14 to and over the sensor 17, thus greatly increasing the strength of the magnetic field or flux at the sensor 17 to preferably about the same strength or intensity of the magnetic field at the sensor 17 when the magnet 14 is oriented relative to the sensor 17 as shown in FIG. 2.

Thus, in accordance with the invention, the presence and use of the magnet pole pieces 22 and 24 assures that the sensed strength or intensity of the magnetic field conducted over the sensor 17 remains generally constant, i.e., nominalized or evened out to some predetermined nominal value and varies only over a small narrow strength range over the full range of rotation of the shaft 12, irrespective of the position of the shaft 12 and the magnet 14 relative to the sensor 17 and further that only the direction of the magnetic field or flux lines 50 changes as the shaft 12 and magnet 14 rotate.

As described above, the Hall effect sensor 17 is of a type that measures magnetic field direction only in view that the sensor 17 is required to have a nearly constant, nominalized magnetic field strength over the full range of measurement such as, for example, the zero degrees measurement position of FIG. 2, the ninety degree measurement position of FIG. 3, and all of the intermediate measurement positions (not shown) between the FIG. 2 and FIG. 3 positions. Additionally, the magnetic field or flux direction at each rotation position needs to reflect the position of the shaft 12. In general, the direction of the magnetic field or flux lines 50 is affected only slightly by the presence of the magnet pole pieces 22 and 24. The field direction condition is already fairly well met by the magnet 14. Any small field direction changes caused by the magnet pole pieces 22 and 24, however, do tend to improve this aspect of operation.

Further, in accordance with the present invention, the presence and use of magnet pole pieces 22 and 24 with respective tapered end segments 36 further concentrates the magnetic flux generated by the magnet 14 over the sensor 17.

Numerous variations and modifications of the embodiment described may be effected without departing from the spirit and scope of the novel features of the invention. It is understood that no limitations with respect to the specific sensor assembly illustrated are intended or should be inferred. It is, of course, intended to cover all such modifications as fall within the scope of the claims.

I claim:

1. A rotary position sensor assembly comprising:
a shaft;
a magnet on the shaft adapted to generate a magnetic flux having a strength and a direction;
a sensor located opposite and spaced from the magnet and adapted to sense and measure a change in the direction of the magnetic flux generated by the magnet in response to a change in the rotary position of the shaft; and
a pair of magnet pole pieces located opposite and spaced from the magnet, the pole pieces being located on opposed sides of and spaced from the sensor and adapted to conduct the magnetic flux over the sensor.

2. The rotary position sensor assembly of claim 1 wherein each of the magnet pole pieces includes a tapered end located opposite and spaced from the sensor and adapted to concentrate the magnetic flux over the sensor.

3. The rotary position sensor assembly of claim 1 wherein each of the magnet pole pieces is curvilinearly shaped and follows the contour of the shaft.

4. The rotary position sensor assembly of claim 1 wherein the magnet, the sensor, and the pair of magnet pole pieces are positioned in a generally co-planar relationship.

5. The rotary position sensor assembly of claim 1 wherein the pair of magnet pole pieces nominalize the strength of the magnetic flux generated by the magnet over the full range of rotation of the shaft relative to the sensor.

6. The rotary position sensor assembly of claim 1 wherein the magnet is in the form of a ring and surrounds the shaft.

7. A rotary position sensor assembly comprising:
an elongate shaft;
a magnet on the shaft and adapted to generate a magnetic flux having a strength and a direction;
a sensor spaced from the shaft and the magnet and adapted to sense and measure a change in the direction of the magnetic flux generated by the magnet in response to a change in the rotary position of the shaft; and
a pair of magnet pole pieces spaced from the shaft and the magnet and located on opposite sides of the sensor, the pair of magnet pole pieces being adapted to maintain the strength of the magnetic flux generally constant irrespective of the rotary position of the shaft and the magnet relative to the sensor.

8. The rotary position sensor assembly of claim 7 wherein the magnet is a ring shaped magnet which surrounds the shaft, each of the pair of magnet pole pieces being shaped to follow the shape of the ring shaped magnet and including a tapered end located opposite the sensor for concentrating the magnetic flux onto the sensor.

9. A rotary position sensor assembly comprising:
an elongate shaft including an exterior surface;
a ring shaped magnet surrounding the exterior surface of the shaft, the magnet being adapted to generate a magnetic flux having a strength and a direction;
a Hall effect integrated circuit sensor chip spaced from the shaft and the magnet and adapted to sense and measure a change in the direction of the magnetic flux generated by the magnet in response to a change in the rotary position of the shaft; and
first and second elongate and curvilinearly shaped magnet pole pieces spaced from the shaft and the magnet and positioned on opposite sides of the Hall effect integrated circuit sensor chip for nominalizing the strength of the magnetic flux sensed by the Hall effect integrated circuit sensor chip over a full range of rotation of the shaft relative to the Hall effect integrated sensor chip.

10. The rotary position sensor assembly of claim 9 wherein each of the first and second magnet pole pieces includes a tapered end located opposite the Hall effect integrated circuit sensor chip for concentrating the magnetic flux over the Hall effect integrated circuit sensor chip.

11. The rotary position sensor assembly of claim 9 wherein each of the first and second magnet pole pieces have the same length, thickness, and width.
